(19) United States
(12) Patent Application Publication
(10) Pub. No.: US 2015/0017617 A1
(43) Pub. Date: Jan. 15, 2015

(54) System and Method for Language Teaching

(71) Applicant: Kenneth Jones, Burke, VA (US)

(72) Inventor: Kenneth Jones, Burke, VA (US)

(21) Appl. No.: 14/147,480

(22) Filed: Jan. 3, 2014

Related U.S. Application Data
(60) Provisional application No. 61/845,245, filed on Jul. 11, 2013.

(51) Int. Cl. G09B 19/06

(52) U.S. Cl. CPC G09B 19/06
USPC 434/157

(57) ABSTRACT

As one implementation example, a system is described which comprises a display media adapted to display a plurality of known words, which form a first grammatical unit, and a plurality of unknown words, which form a second grammatical unit. The plurality of known words and the plurality of unknown words are associated with each other on a word per word basis by a code.

### CROSS-REFERENCE TO RELATED APPLICATIONS

The present Utility patent application claims priority benefit of the U.S. provisional application for patent Ser. No. 61/845,245 entitled “Image Transfer In Context Method”, filed on 11 Jul. 2013 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to language teaching methods. More particularly, the invention relates to a language teaching system and method that defines words and grammatical units in an unknown language by coding with known languages.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that language is the human capacity for acquiring and using complex systems of communication, and a language is any specific example of such a system. The scientific study of language is called linguistics.

Often, linguistics can be broadly broken into three categories or subfields of study: language form, language meaning, and language in context. Linguistics can include the study of language structure, or grammar.

In many instances, grammatical studies focus on the system of rules followed by the users of a language. It includes the study of morphology (the formation and composition of words), syntax (the formation and composition of phrases and sentences from these words), and phonology (sound systems). The languages that are most spoken in the world today belong to the Indo-European family, which includes languages such as English, Spanish, Portuguese, Russian, and Hindi; the Sino-Tibetan languages, which include Mandarin Chinese, Cantonese, and many others; the Afro-Asiatic family, which include Arabic, Amharic, Somali, and Hebrew; and the Bantu languages, which include Swahili, Zulu, and Shona.

In view of the foregoing, it is clear traditional techniques of language teaching are not perfect and leave room for more optimal approaches.

Most popular language teaching methods are based upon the immersion approach which uses the unknown language only. Immersion methods rely upon pictures, symbols and audio recordings by a native speaker of the unknown language. Immersion methods make it difficult or impossible to tap into the huge database of general grammar, vocabulary and verbal knowledge that the speaker of a known language already possesses. Learning a language through the immersion approach with pictures and symbols alone can lead to speaking broken language: language that does not use proper grammatical structures or proper verb conjugations.

Although immersion approaches are accepted by most language authorities as the gold standard of teaching, these approaches are not effective for most adults. Most children can absorb a language by being immersed in it, but adults need structure and sound learning methodology. New knowledge should be integrated into the adult mind in harmony with the knowledge that already exists there. As opposed the immersion approach, this language teaching method (also named the Image Transfer In Context method) teaches the grammatical structure of the unknown language by comparing it to the grammatical structure of the known language and defines one hundred percent of the unknown language vocabulary with known language vocabulary.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1D illustrate exemplary coded grammatical unit pair formats for an exemplary known language and an exemplary unknown language in stacked arrangements, where FIG. 1A illustrates exemplary color codes, FIG. 1B illustrate exemplary number codes, FIG. 1C illustrates exemplary color and number codes, and FIG. 1D illustrate exemplary number sequencing codes, in accordance with an embodiment of the present invention;

FIGS. 2A-2D illustrate exemplary coded grammatical unit pair formats for an exemplary known language and an exemplary unknown language in linear arrangements, where FIG. 2A illustrates exemplary color codes, FIG. 2B illustrate exemplary number codes, FIG. 2C illustrates exemplary color and number codes, and FIG. 2D illustrate exemplary number sequencing codes, in accordance with an embodiment of the present invention;

FIG. 3 illustrates an exemplary coded complex grammatical unit, in accordance with an embodiment of the present invention;

FIGS. 4A and 4B illustrate exemplary coded grammatical units in groups having a question pair of grammatical units and an answer pair of grammatical units, where FIG. 4A illustrates a stacked format of groups, and FIG. 4B illustrates a linear format of groups, in accordance with an embodiment of the present invention;

FIG. 5 illustrates a flowchart diagram of an exemplary language teaching method, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

The term “grammatical unit” refers to a phrase, a clause, a sentence, or any equivalent thereof.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings. There are various types of language teaching systems and methods that may be provided by preferred embodiments of the present invention. In one embodiment of the present invention, a language teaching system may present a coded word or coded grammatical unit in a known language, and a substantially equivalent coded word or coded grammatical unit in an unknown language. The unknown language grammatical unit and the known language grammatical unit may be compared to each other to illustrate correct word order, syntax, and grammar of the unknown language grammatical unit. Additionally, both the known and the unknown language may be systematically read to teach vocabulary, grammar, fluency in speaking, and fluency in listening. In some embodiments, the unknown language may include, without limitation, a foreign language being learned by a user. The known language may include, without limitation, a language which the user is familiar with the grammatical and syntax rules. In some embodiments, the language teaching method may act as both a dictionary, to define every word of an unknown language grammatical unit, and as a syntactical reference that shows the relative positions of words in the correct grammatical syntax of both languages. Those skilled in the art, in light of the present teachings, will recognize that the language teaching method may be efficacious for defining unknown vocabulary, illustrating unknown grammar, and allowing a user to practice unknown speaking fluency and listening fluency simultaneously without succumbing to interference or negative transfer from the known language.

In one embodiment, the language teaching system may utilize a systematic method. An unknown word from an unknown grammatical unit may be read first. A corresponding known word from a known grammatical unit, and in the same coded grammatical unit pair as the unknown word, may be read immediately afterword. In this manner, both the known and the unknown language may be systematically read to teach vocabulary, grammar, fluency in speaking and fluency in listening. In some embodiments, a pair of the words or grammatical units from each language may position in proximity to each other. The grammatical unit may be arranged in various proximal positions, including, without limitation, a stacked format and a linear format. In either format, the words and the grammatical unit are visually proximal to each other for efficient analysis of the codes and words. The substantially similar words or grammatical units may include a code to provide comparative analysis of the word and linguistic features between the known word and the unknown word.

In one embodiment, a pair of words or grammatical units from each language may position in proximity to each other. The substantially similar words or grammatical units may then be coded to provide comparative analysis of the word and linguistic features. In some embodiments, the code may include, without limitation, a color, a number, a letter, or an indicator to help define the word, part of the word, or the grammatical unit. The code may help define substantially similar words and grammatical units in the known language and the unknown language. For example, without limitation, in the grammatical unit: “The apple fell off the tree.” the word “apple” may be color coded red in both the known and the unknown language. Similarly, the word “tree” may be color coded brown in both languages. In this manner, the pair of words and grammatical units is coded by color, number, letter or other indicator and in context in both languages, and visual comparison of relative locations of words and grammatical units is made possible. Additionally, grammatical concepts may be learned with the present embodiment.

In one embodiment of the present invention, a language teaching method may include steps for presenting the coded word or grammatical unit in a known language and the substantially equivalent coded word or grammatical unit in an unknown language. A first Step may include presenting one or more pairs of coded words and grammatical unit pairs in the known language and the unknown language. The coded grammatical unit pair may serve as a dictionary and a grammatical unit syntax map. Both languages are presented according to their correct rules of syntax and grammar. A further Step may include reading the first word in the unknown language. The language teaching method may then proceed to a next Step of reading the corresponding word, part of a word or words in the known language that have a matching code, or that is next in the code sequence. An additional Step may include continuing to read each unknown word or words and corresponding known word, part of a word or words having matching codes or that is next within the code sequence until every word of both languages is read. A next Step may include repeating the above steps for additional pairs of words and grammatical units, if present. A final Step may include reading the unknown language fluently in correct grammatical form.

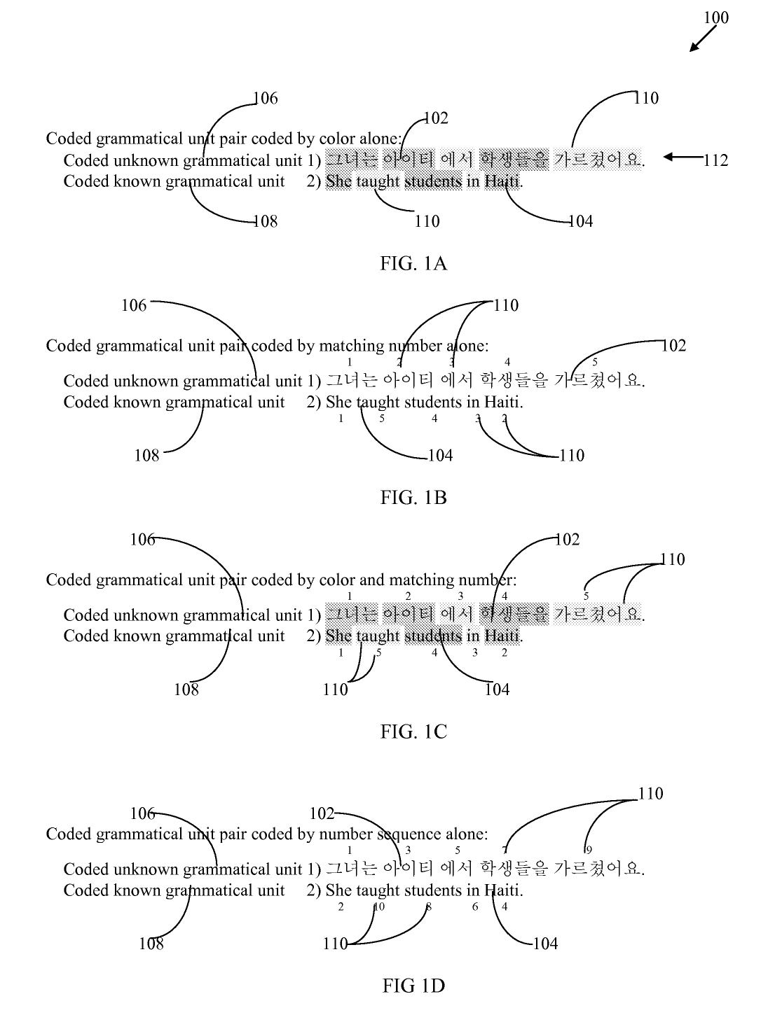

FIGS. 1A-1D illustrate exemplary coded grammatical unit pair formats for an exemplary known language and an exemplary unknown language in stacked arrangements, where FIG. 1A illustrates exemplary color codes, FIG. 1B illustrate exemplary number codes, FIG. 1C illustrates exemplary color and number codes, and FIG. 1D illustrate exemplary number sequencing codes, in accordance with an embodiment of the present invention. In the present embodiment, a language teaching system 100 may present a coded word or grammatical unit in a known language and a substantially equivalent coded word or grammatical unit in an unknown language. The unknown language grammatical unit and the known language grammatical unit may be compared to each other to illustrate correct word order, syntax, and grammar of the unknown language grammatical unit. The unknown language may include, without limitation, a foreign language being learned by a user. The known language may include, without limitation, a language in which the user is familiar with the vocabulary, grammatical and syntax rules. The language teaching method may act as both, a dictionary to define every word of an unknown language grammatical unit, and as a reference that shows the relative positions of words in the correct grammatical syntax of both languages. In this manner, the unknown language grammatical unit and the known language grammatical unit may be compared to each other to illustrate correct word order of the unknown language grammatical unit. Additionally, both the known language and the unknown language may be systematically read to teach vocabulary, grammar, fluency in speaking, and fluency in listening. Those skilled in the art, in light of the present teachings, will recognize that the language teaching method may be efficacious for defining unknown language vocabulary, illustrating unknown language grammar, and allowing a user to practice unknown language speaking fluency and listening fluency simultaneously without succumbing to interference or negative transfer from the known language.

In one embodiment of the present invention, the language teaching system may utilize a systematic method. In this method, an unknown word 102 from an unknown grammatical unit 106 may be read first. A corresponding known word 104 from a known grammatical unit 108, and in the same coded grammatical unit pair as the unknown word, may be read immediately afterword. In this manner, both the unknown and the known language may be systematically read to teach vocabulary, grammar, fluency in speaking and fluency in listening. In some embodiments, a pair of the words or grammatical units from each language may position in proximity to each other. The grammatical unit may be arranged in various proximal positions, including, without limitation, a stacked format and a linear format. In either format, the words and the grammatical unit are visually proximal to each other for efficient analysis of the code and the words. The substantially similar words or grammatical units may include a code 110 to provide comparative analysis of the word and linguistic features between the known word and the unknown word.

In some embodiments, the code may include, without limitation, a color, a number, a letter, an indicator, parenthesis or any combination of a color, a number, a letter, parenthesis or an indicator to help define a word of a grammatical unit. The code may help define substantially similar words and grammatical units in the known language and the unknown language. In some embodiments, the code may include, without limitation only a color to compare the known language with the unknown language, whereby each substantially similar word is colored the same. The code may further include a number code, whereby each substantially similar word shares the same number. The code may further comprise both a color and a number, whereby each substantially similar word share the same color and number. The code may further include a number sequence, whereby each substantially similar word or part of words is numbered sequentially. For example, without limitation, the unknown language may include the series of, “1, 3, 5, . . . ” while the known language may include the series of “2, 4, 6, . . . ” The word “1” may correlate to the word “2”; the “3” may correlate to the “4”, and so forth. The grammatical unit may be arranged in either a stacked format 112 or a linear format. In this manner, the pair of words and grammatical units is coded by a color, a number, a letter, parenthesis, other indicator or any combination of a color, a number, a letter, parenthesis or other indicator. The grammatical units are in context in both languages, and visual comparison of relative locations of words and grammatical units is made possible. Additionally, grammatical concepts may be learned with the present embodiment.

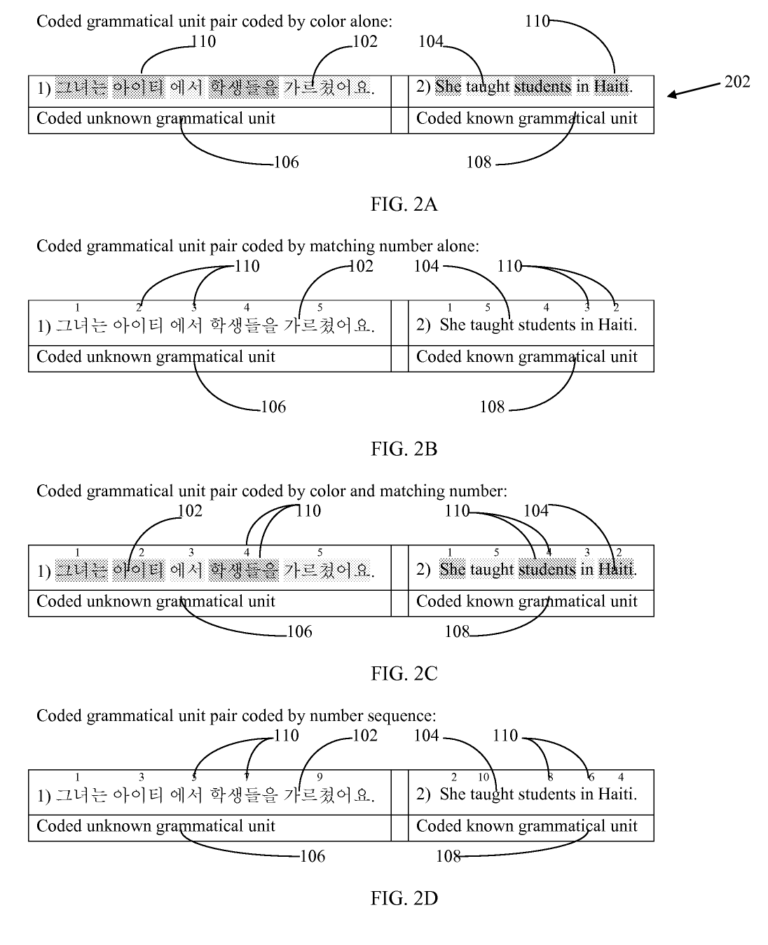

FIGS. 2A-2D illustrate exemplary coded grammatical unit pair formats for an exemplary unknown language and an exemplary known language in linear arrangements, where FIG. 2A illustrates exemplary color codes, FIG. 2B illustrates exemplary number codes, FIG. 2C illustrates exemplary color and number codes, and FIG. 2D illustrates exemplary number sequencing codes, in accordance with an embodiment of the present invention. In the present embodiment, visual comparison of relative locations of words and grammatical units may be formatted in a linear format 202. While the stacked format 112 allows for closer proximity comparison (the words are above or below each other), it may require an additional iteration of the grammatical units in the unknown language to avoid negative transfer. The linear format requires no additional iteration of the grammatical units; the known language may be covered by a hand, piece of paper or other means of hiding it and then the unknown language can be practiced without interference from the known language. Similar to the stacked format 112, the linear format codes the words in the unknown grammatical unit and the known grammatical unit. For example (from FIG. 1A), without limitation, a pair of grammatical units may be presented as follows:

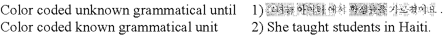

The above example represents a pair of grammatical units made up of one coded unknown grammatical unit and one coded known translation of the unknown grammatical unit presented in their correct grammatical forms. In this example, a coded grammatical unit pair exemplifies a user who knows English, the known language, and is learning Korean, the unknown language.

In the above example, the user may initially read the unknown language coded word in the unknown grammatical unit. The user may then read a corresponding known language word, part of a word or words with a matching code indicator or that is next in the code sequence in a coded, grammatically correct translation of the unknown grammatical unit. In some embodiments, this may be accomplished by reading the gold shaded unknown word “ [symbol] ” and then reading the gold shaded known word “She”. After reading the gold shaded word “she” the user may pause for a moment to allow an image of “she” to come into his or her mind. The image of “she” may become associated with and transfer to the word “ [symbol] ”. The relative position of “ [symbol] ” in the unknown grammatical unit structure to “she” in the known grammatical unit structure may then be automatically learned. Reading the unknown word first allows the reader to practice the unknown grammatical unit structure. In other words, the unknown language's word order is practiced by reading the unknown word first and allowing the unknown language to lead in all subsequent single word definition. This allows the user to define unknown single word vocabulary and practice unknown language word order simultaneously.

In some embodiments, the language teaching method example may comprise continuing to read each unknown word or words and corresponding known word, part of a word or words that have a matching code, or that is next in the code sequence until every word of both languages is read. A blue shaded “ [symbol] ” is read and a blue shaded “Haiti” is read immediately afterward. The user may then pause for image transfer. A green shaded “ [symbol] ” is read and a green shaded “in” is read immediately afterward. The user may pause again for image transfer. A pink shaded “ [symbol] ” is read and a pink shaded “students” is read immediately afterward. The user may pause yet again for image transfer, whereby the text becomes integrated with the meaning of the word. A yellow shaded “ [symbol] ” is read and a yellow shaded “taught” may be read immediately afterward. The user may pause for image transfer. This is the end of the unknown grammatical unit. In one embodiment, the language teaching method example may further comprise reading the coded unknown grammatical unit fluently in correct grammatical form. The user may then practice speaking fluency and listening fluency by reading or reciting the entire unknown grammatical unit as a complete idea. The user may then cover the known language grammatical unit with a piece of paper, index card or other such device and read the unknown language grammatical unit fluently: “ [symbol] [symbol] [symbol] [symbol] [symbol] ”. Additionally, the user may pause momentarily after reading each word to think of the image associated with that word.

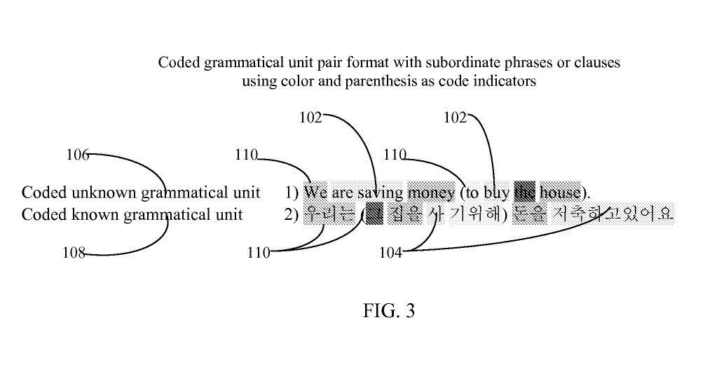

An example from FIG. 3 illustrates an exemplary coded complex grammatical unit that is coded by color and parenthesis in accordance with an embodiment of the present invention. For example, without limitation, a coded grammatical unit pair with subordinate phrases or clauses may be presented as follows:

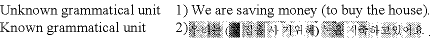

The above example represents a pair of more complex grammatical units made up of one coded unknown grammatical unit and one coded known translation of the unknown grammatical unit presented in their correct grammatical forms. In this example, a coded grammatical unit pair exemplifies a user who knows Korean, the known language, and is learning English, the unknown language.

In the above example, the user may initially read the unknown language coded word in the unknown grammatical unit. The user may then read a corresponding known language word, part of a word or words with a matching code indicator or that is next in the code sequence in a coded, grammatically correct translation of the unknown grammatical unit. In some embodiments, this may be accomplished by reading the gold shaded unknown word “We” and then reading the gold shaded known word “ [symbol] ”. After reading the gold shaded word “we” the user may pause for a moment to allow an image of “ [symbol] ” to come into the mind. The image of “ [symbol] ” may transfer to the word “we”. The relative position of “we” in the unknown grammatical unit structure to “ [symbol] ” in the known grammatical unit structure may then be automatically learned.

In some embodiments, the language teaching method example may comprise continuing to read each unknown word or words and corresponding known word, part of a word or words that have a matching code or that is next in the code sequence until every word of both languages is read. The yellow shaded words “are saving” may be read and yellow shaded “ [symbol] ” may be read immediately afterward. The user may pause for image transfer. The pink shaded word “money” may be read and a pink shaded “ [symbol] ” may read immediately afterward. The user may pause for image transfer. Next the words additionally coded with parenthesis may be read according to the word order in the unknown grammatical unit: A light blue shaded “to” may be read and a light blue shaded “ [symbol] ” may be read immediately afterward. The user may pause for image transfer. A yellow shaded “buy” may be read and a yellow shaded “ [symbol] ” may be read immediately afterward. The user may pause for image transfer. A red shaded “the” may be read and a red shaded “ [symbol] ” may be read immediately afterward. The user may pause for image transfer. A pink shaded “house” may be read and a pink shaded “ [symbol] ” may be read immediately afterward. The user may once again pause for image transfer. This may be the end of the unknown grammatical unit in the above example. In one embodiment, the language teaching method example may further comprise covering the known language grammatical unit with a piece or paper, an index card or other such device and reading the coded unknown grammatical unit fluently in correct grammatical form as a complete idea: “ [symbol] [symbol] [symbol] [symbol] [symbol] [symbol] [symbol] [symbol] ”. The user may pause momentarily after reading each word to think of the image associated with that word. Those skilled in the art will recognize that the parenthesis is an additional code indicator and may serve as a guide to segregate subordinate phrases or clauses within the grammatical unit. This allows for the re-use of color codes that were used in the main grammatical unit to code words in subordinate phrases and clauses as well.

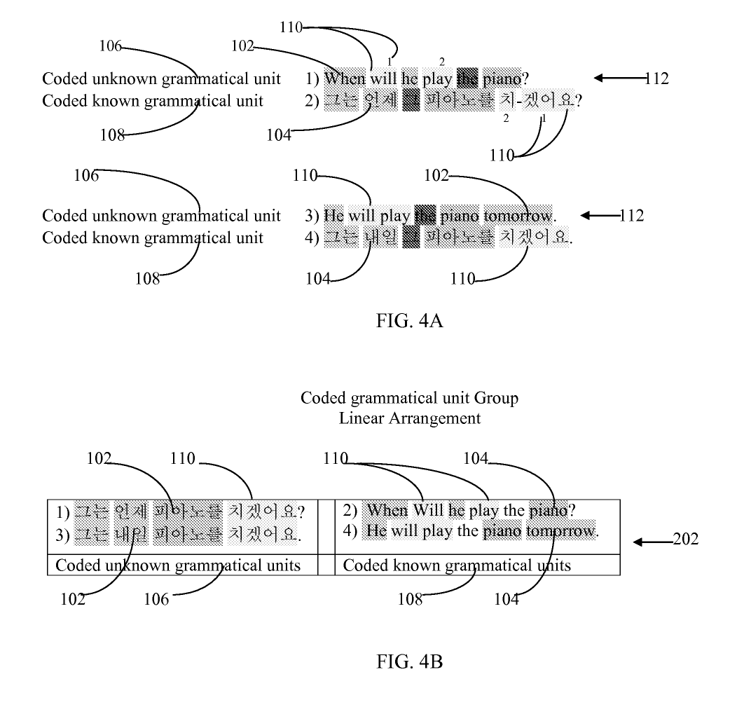

FIGS. 4A and 4B illustrate exemplary coded grammatical units in a group having a question pair of grammatical units and an answer pair of grammatical units, where FIG. 4A illustrates a stacked format of a group, and FIG. 4B illustrates a linear format of a group, in accordance with an embodiment of the present invention. In the present embodiment, the language teaching system may form groups of the pairs of grammatical units. Each pair of grammatical units may integrate with others to form a more complex chain of communication. For example (from FIG. 4A), without limitation, coded grammatical unit pairs in a group may be presented as follows:

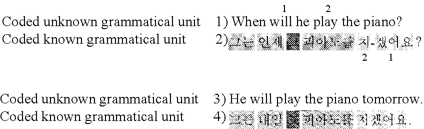

And an un-coded iteration of the unknown language in grammatical units 1 and 3 may be presented as follows:
When will he play the piano?
He will play the piano tomorrow.
The above example represents coded grammatical unit pair 1 and 2 and coded grammatical unit pair 3 and 4 that are made up of one coded unknown grammatical unit and one coded known translation of the unknown grammatical unit presented in their correct grammatical forms. In this example, the coded grammatical unit pairs exemplify a user who knows Korean, the known language, and is learning English, the unknown language.

In the above example, the user may initially read the unknown language coded word in the unknown grammatical unit. The user may then read a corresponding known language word, part of a word or words with a matching code indicator or that is next in the code sequence in a coded, grammatically correct translation of the unknown grammatical unit. In some embodiments, this may be accomplished by reading a blue shaded unknown word “when” and then reading a blue shaded known word “ [symbol] ”. After reading the blue shaded word “ [symbol] ” the user may pause for a moment to allow an image associated with “ [symbol] ” to come into the mind. The image associated with “ [symbol] ” may transfer to the word “when”. The relative position of “when” in the unknown grammatical unit structure to “ [symbol] ” in the known grammatical unit structure may then be easily learned.

In some embodiments, the language teaching method example may comprise continuing to read each unknown word or words and corresponding known word, part of a word or words that have a matching code, or that is next in the code sequence until every word of both languages is read. A yellow shaded and numbered “will” may be read and a yellow shaded and numbered word part “ [symbol] ” may be read immediately afterward. The user may pause for image transfer. Those skilled in the art, in light of the present teachings, will recognize that the Korean verb [symbol] is split into [symbol] and [symbol] according to its rules of conjugation to reflect the English split question-verb style. A gold shaded “he” may be read and a gold shaded “ [symbol] ” may be read immediately afterward. The user may once again pause for image transfer. A yellow shaded and numbered “play” may be read and a yellow shaded and numbered word part “ [symbol] ” (literally hit) may be read immediately afterward. The user may once again pause for image transfer. A red shaded “the” may be read and a red shaded “ [symbol] ” may be read immediately afterward. The user may pause for image transfer. A pink shaded “Piano” may be read and a pink shaded “ [symbol] ” may be read immediately afterward. The user may then pause for image transfer.

Additionally, the grammatical units 3 and 4 in the above group of grammatical units, may include reading a gold shaded “he”, and then reading gold shaded “ [symbol] ” immediately afterward. The user may then pause for image transfer. The yellow shaded words “will play” may be read and the yellow shaded word “ [symbol] ” may be read immediately afterward. The user may pause for image transfer. A red shaded word “the” may next be read and a red shaded “ [symbol] ” may be read immediately afterward. The user may once again pause for image transfer. A pink shaded “piano” may be read and a pink shaded “ [symbol] ” may be read immediately afterward. The user may once again pause for image transfer. A blue shaded “tomorrow” may be read and a blue shaded “ [symbol] ” may be read immediately afterward. The user may pause for image transfer.

In one embodiment, the language teaching method example may further comprise reading the unknown grammatical units fluently in correct grammatical form as a complete idea. This can be done by covering the known language with a piece of paper, index card or other such device and reading: “ [symbol] [symbol] [symbol] [symbol] [symbol] [symbol] ?” and “ [symbol] [symbol] [symbol] [symbol] [symbol] [symbol] ” or by reading a separate iteration of the unknown language from grammatical units 1 and 3 without coding: “When will he play the piano? He will play the piano tomorrow”. Reading the unknown grammatical units fluently as a complete idea allows the user to learn the unknown language without negative interference from the known language. The student may also learn the differences and similarities between the question form and answer form of the same grammatical unit which is an essential skill in engaging another speaker of the unknown language under study in conversation.

An additional example from FIG. 4B, without limitation of coded grammatical unit pairs in a group arranged in a linear format may be presented as follows:

| | |
|---|---|
| 1) [symbol] ? 3) [symbol] . | 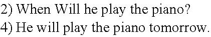 |
| Coded unknown grammatical units | Coded known grammatical units |

The above example represents two pairs of grammatical units made up of one coded unknown grammatical unit and one coded known translation of the unknown grammatical unit presented in their correct grammatical forms. In this example, a coded grammatical unit pair exemplifies a user who knows English, the known language, and is learning Korean, the unknown language.

In the above example, the user may initially read the unknown language coded word in the unknown grammatical unit. The user may then read a corresponding known language word, part of a word or words with a matching code indicator or that is next in the code sequence in a coded, grammatically correct translation of the unknown grammatical unit. In grammatical units 1 and 2, this may be accomplished by reading a gold shaded unknown word “ [symbol] ” and then reading a gold shaded known word “he” immediately afterward. After reading the gold shaded word “he” the user may pause for a moment to allow an image associated with “he” to transfer to the word “ [symbol] ”. The relative position of “ [symbol] ” in the unknown grammatical unit structure to “he” in the known grammatical unit structure may be automatically learned.

In some embodiments, the language teaching method example may comprise continuing to read each unknown word or words and corresponding known word, part of a word or words that have a matching code, or that is next in the code sequence until every word of both languages is read. A blue shaded unknown word “ [symbol] ” may be read and a blue shaded known word “when” may be read immediately afterward. The user may pause for image transfer. A pink shaded “ [symbol] ” may be read and a pink shaded “Piano” may be read immediately afterward. The user may pause for image transfer. A yellow shaded “ [symbol] ” may be read and yellow shaded words “will” and “play” may be read immediately afterward. The user may once again pause for image transfer.

In grammatical units 3 and 4, the user may read a gold shaded “ [symbol] ”, and gold shaded “he” may be read immediately afterward. A blue shaded “ [symbol] ” may be read and blue shaded “tomorrow” may be read immediately afterward. A pink shaded “ [symbol] ” may be read and pink shaded “piano” may be read immediately afterward. A yellow shaded “ [symbol] ” may be read and yellow shaded words “will play” may be read immediately afterward. The user may pause for image transfer. In one embodiment, the language teaching method example may further comprise reading the coded unknown grammatical units 1 and 3 fluently in correct grammatical form. The user may block out the known language grammatical units 2 and 4 with his or her hand, a piece of paper, index card or by some other means and practice speaking fluency and listening fluency by reading or reciting the unknown grammatical units as complete ideas:

[symbol]

[symbol]

[symbol]

[symbol]

[symbol]

[symbol]

[symbol]

[symbol]

The above example may be efficacious in teaching the grammatical lesson of question grammatical unit-answer grammatical unit comparison to allow the user to learn the differences and similarities between the question form and answer form of the same grammatical unit. Those skilled in the art will recognize that if the user can produce a question grammatical unit from an answer grammatical unit or vise-versa, it can be a first step in engaging another speaker of the unknown language under study in conversation.

In one embodiment of the present invention, the language teaching system may be presented through various media and formats, including, without limitation, flashcards, book format, memory game, board game, software applications, smart-phones, tablets, or other mobile device. In yet another embodiment, the language teaching system may be utilized by one user with the assistance of CDs or other recorded voice media. The system may also be used by a teacher in a class room setting or by two people, preferably one who knows one language and another who knows the other language of the two languages under study.

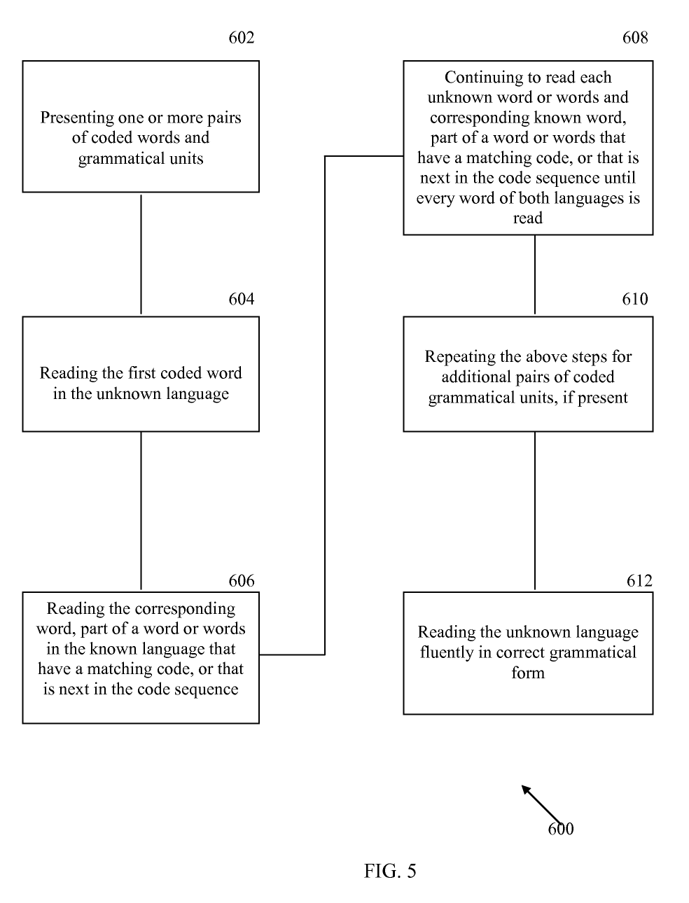

FIG. 5 illustrates a flowchart diagram of an exemplary language teaching method, in accordance with an embodiment of the present invention. In the present embodiment, a language teaching method 600 may include steps for presenting the coded word or grammatical unit in a known language and the substantially equivalent coded word or grammatical unit in an unknown language. A first Step 602 may include presenting one or more pairs of coded words and grammatical unit pairs in the known language and the unknown language. Both languages are presented according to their correct rules of syntax and grammar. A further Step 604 may include reading the first word in the unknown language. The language teaching method may then proceed to a next Step 606 of reading the corresponding word, part of a word or words in the known language that have a matching code, or that is next in the code sequence. An additional Step 608 may include continuing to read each unknown word or words and corresponding known word, part of a word or words that have a matching code or that is next in the code sequence until every word of both languages is read. A next Step 610 may include repeating the above steps for additional pairs of words and grammatical units, if present. A final Step 612 may include reading the unknown language fluently in correct grammatical form.

In one alternative embodiment, an audio portion may dictate the word and grammatical unit while the user reads to reinforce the lesson in the user's mind. In yet another alternative embodiment, an additional dialect of the unknown language may be arranged in proximity to the known grammatical unit and the unknown grammatical unit to provide further insight into the unknown language. In yet another alternative embodiment, the language teaching system may include grammatical rules in proximity to the unknown grammatical unit and the known grammatical unit to provide additional grammatical information. In yet another alternative embodiment, the known grammatical unit and the unknown grammatical unit may be separated onto different flashcards.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a language learning system that codes a known grammatical unit and an unknown grammatical unit according to the present invention will be apparent to those skilled in the art. Various aspects of the invention have been described above by way of illustration, and the specific embodiments disclosed are not intended to limit the invention to the particular forms disclosed. The particular implementation of the language learning system that codes a known grammatical unit and an unknown grammatical unit may vary depending upon the particular context or application. By way of example, and not limitation, the language learning system that codes a known grammatical unit and an unknown grammatical unit described in the foregoing were principally directed to providing the same code to substantially similar words in a known language and an unknown language to learn the syntax and grammar of the unknown language implementations; however, similar techniques are contemplated to be applicable to learning nonhuman languages, such as computer code, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A language teaching system comprising:
a display media adapted to display:
a plurality of unknown words adapted to form a first grammatical unit; and
a first plurality of known words adapted to form a second grammatical unit,
wherein the plurality of unknown words and the first plurality of known words are associated with each other by a code.

2. The system of claim 1, wherein the first grammatical unit and the second grammatical unit are oriented to be displayed in a substantially linear fashion.

3. The system of claim 1, wherein the first grammatical unit and the second grammatical unit are oriented to be displayed in a stacked fashion.

4. The system of claim 1, wherein said code is a color, a number, a letter, parenthesis, other indicator or any combination of a color, a number, a letter, parenthesis or other indicator.

5. The system of claim 1, wherein the display media is further adapted to display a second plurality of unknown words adapted to form a third grammatical unit,
wherein the third grammatical unit is displayed in proximity to the first grammatical unit and the second grammatical unit, the second plurality of unknown words being in a different dialect than the first plurality of unknown words.

6. The system of claim 1, wherein the display media is further adapted to display a grammatical rule in proximity to the first grammatical unit and the second grammatical unit.

7. The system of claim 1, wherein the first grammatical unit and the second grammatical unit form a first grammatical unit pair,
wherein the display media is further adapted to display a third grammatical unit and a fourth grammatical unit, and
wherein the third grammatical unit and the fourth grammatical unit form a second grammatical unit pair.
wherein the display media is further adapted to display any number of grammatical units and
wherein any two grammatical units in close proximity may form a grammatical unit pair.

8. The system of claim 1, wherein the display media is a flashcard.

9. The system of claim 1, wherein the display media is a computer or mobile device.

10. The system of claim 8, wherein the first grammatical unit and the second grammatical unit are separated onto different flashcards.

11. The system of claim 1, further comprising an audio device adapted to dictate at least a portion of the first grammatical unit or the second grammatical unit.

12. The system of claim 11, wherein the audio device is a stereo.

13. The system of claim 11, wherein the audio device is an mp3 player or a computer.

14. The system of claim 1, wherein the first grammatical unit and the second grammatical unit form a first grammatical unit pair,
wherein the display media is further adapted to display a grammatical rule in proximity to the first grammatical unit and the second grammatical unit,
wherein the display media is further adapted to display a third grammatical unit and a fourth grammatical unit,
wherein the third grammatical unit and the fourth grammatical unit form a second grammatical unit pair; and
further comprising an audio device adapted to dictate at least a portion of the first grammatical unit or the second grammatical unit.

15. A method comprising:
first, reading a first unknown word in an unknown language, wherein the first word comprises a code or a sequence indicator;
second, reading a corresponding word, part of a word or words in a known language, wherein the corresponding word, part of a word or words comprise a matching code or is next in a code sequence; and
third, reading a next unknown word or words and a next corresponding word, part of a word or words based on the matching code or the code sequence, until every word of both the unknown language and the known language are read.

16. The method of claim 15, further comprising repeating the first through third steps for additional pairs of words or grammatical units.

17. The method of claim 15, wherein said code and said matching code are a color, a number, a letter, parenthesis, other indicator or any combination of a color, a number, a letter, parenthesis or other indicator.

18. The method of claim 15, wherein said sequence indicator is a character capable of indicating sequential order.

19. The method of claim 15, wherein said code sequence is a number list in increasing order.

20. A language teaching system comprising:
a display media means for displaying:
a plurality of unknown words adapted to form a first grammatical unit; and
a first plurality of known words adapted to form a second grammatical unit,
wherein the plurality of unknown words and the first plurality of known words are associated with each other by a code; and
an audio device means for dictating at least a portion of the first grammatical unit or the second grammatical unit to the user.
